(19) United States
(12) Patent Application Publication
(10) Pub. No.: US 2008/0032271 A1
(43) Pub. Date: Feb. 7, 2008

(54) Method and System for Evaluating Athletes

(76) Inventor: Daniel A. Johnson, Jonesboro, AR (US)

Correspondence Address: HUSCH & EPPENBERGER, LLC, 190 CARONDELET PLAZA, SUITE 600, ST. LOUIS, MO, 63105-3441, US

(21) Appl. No.: 11/675,762

(22) Filed: Feb. 16, 2007

Related U.S. Application Data
(60) Provisional application No. 60/774,552, filed on Feb. 17, 2006.

(51) Int. Cl. A63B 69/00; G09B 19/00

(52) U.S. Cl. 434/258; 434/322

(57) ABSTRACT

A method and system of evaluating athletes includes the steps of subjecting an athlete to a first battery of objective tests directed to the athlete's functioning brain capacity; determining a set of test scores for the athlete; providing a data base comprising of competitive test scores from another athlete sharing at least one common identifier with the athlete being evaluated; comparing the test scores of both athletes; and ranking the test scores the athlete being evaluated relative to the competitive test scores of the other athlete. In one embodiment, the objective tests are directed to measuring the athlete's short term memory, learning, reasoning/problem solving, attentional focus, short term memory retention, processing speed, and visual motor capacity.

### CROSS REFERENCE

This application claims the priority of provisional application Ser. No. 60/774,552, filed Feb. 17, 2006.

### BACKGROUND OF THE INVENTION

The present invention relates generally to the field of cognitive analysis and more particularly to an improved method and system for analyzing the potential of an athlete to succeed at a given level of competition.

### BACKGROUND OF THE INVENTION

Evaluation of athletes, for example, by professional teams prior to a league draft or collegiate teams prior to extending a scholarship offer, focuses primarily on the physical capabilities of the athlete. However, the mental capabilities of athletes have been proven to be at least as important. Unfortunately, very few reliable testing methodologies have been developed to accurately assess the relevant mental capabilities of athletes.

One example of a test that has been developed is the Wonderlic test. The Wonderlic is essentially a reading comprehension test and has little correlation to actual brain functioning. It merely provides a “number” where before there was no number. Unfortunately, it does not actually measure what it is supposed to be measuring. For example, a player's speed in the forty yard dash actually measures how fast they can run. However, the Wonderlic does not actually measure how well a player can use their brain during competition. In addition, because it is exclusively verbal, athletes from less than optimal educational backgrounds are at a distinct disadvantage in taking the Wonderlic.

Other assessment services in use are group administered hand-out screenings that typically utilize a single timed task combined with a couple of questionnaires that rely on a player's reading comprehension and own opinions of themselves to draw vague-generalized conclusions that read like a horoscope. Afterwards, an organization still has no real insight into a player's cognitive strengths and weaknesses. Measures of personality used at formal evaluation combines or at other screenings have proven essentially useless. Athletes are understandably guarded and endorse items with an overwhelming positive response bias.

Being around athletes their entire life, many professional scouts and collegiate recruiters do have some innate capability to sense which athletes possess the mental and emotional capability to succeed. Beyond that, none of the current evaluation techniques can actually objectively predict when or if a “normal” functioning athlete will develop an emotional or behavioral problem.

Therefore, it would be advantageous to provide an improved method and system of evaluating athletes that provides an objective measure of each individual's mental capabilities and that operates independently of the individual's respective educational background.

The present invention is directed to overcoming one or more of the problems set forth above.

### SUMMARY OF THE INVENTION

One aspect of the invention generally pertains to a method and system for evaluating athletes that provides an objective measure of each individual's mental capabilities.

Another aspect of the invention is to provide a method and system for evaluating athletes that offers a means for evaluating individual's mental capabilities independently of the individual's educational background.

In one embodiment of the invention, there is provided a method of evaluating athletes that includes the steps of subjecting an athlete to a first battery of objective tests directed to the athlete's functioning brain capacity; determining a set of test scores for the athlete; providing a data base comprising of competitive test scores from another athlete sharing at least one common identifier with the athlete being evaluated; comparing the test scores of both athletes; and ranking the test scores the athlete being evaluated relative to the competitive test scores of the other athlete.

In another embodiment of the invention, there is provided a method of evaluating athletes that includes a series of objective tests to measure short term memory, learning, reasoning/problem solving, attentional focus, short term memory retention, processing speed, and visual motor capacity.

In yet another embodiment, the method also includes the steps of identifying a set of specific issues associated with the athlete's on-field performance; subjecting the athlete to a second battery of objective tests directed to those specific issues; determining a second set of test scores for the athlete; providing at least a second set of competitive scores from the other athlete within the data base; comparing the second set of test scores for the athlete with the second set of competitive test scores; and ranking the second set of test scores for the athlete relative to the second set of competitive test scores.

In another embodiment, the method further includes the step of further comprising the step of interviewing the athlete to assess specific deficiencies in the athlete's cognitive functioning.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a sample of a player report generated by a method and system for evaluating athletes according to one embodiment of the present invention.

FIGS. 2-17 are illustrations of sample worksheets incorporating a battery of objective tests associated with the first phase of a method for evaluating athletes according to another embodiment.

### DESCRIPTION OF THE PREFERRED EMBODIMENTS

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

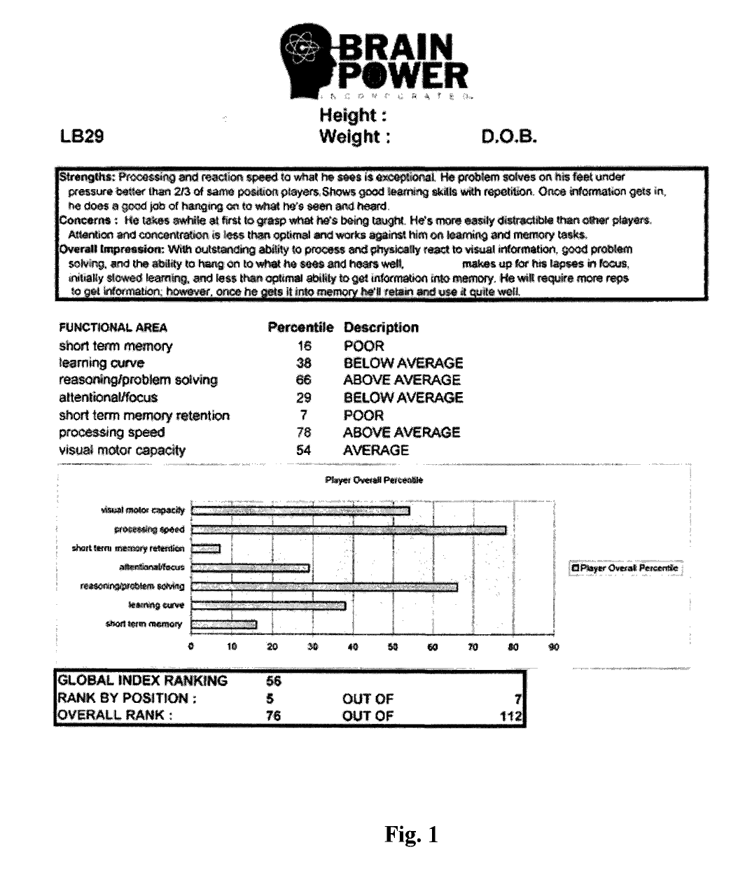

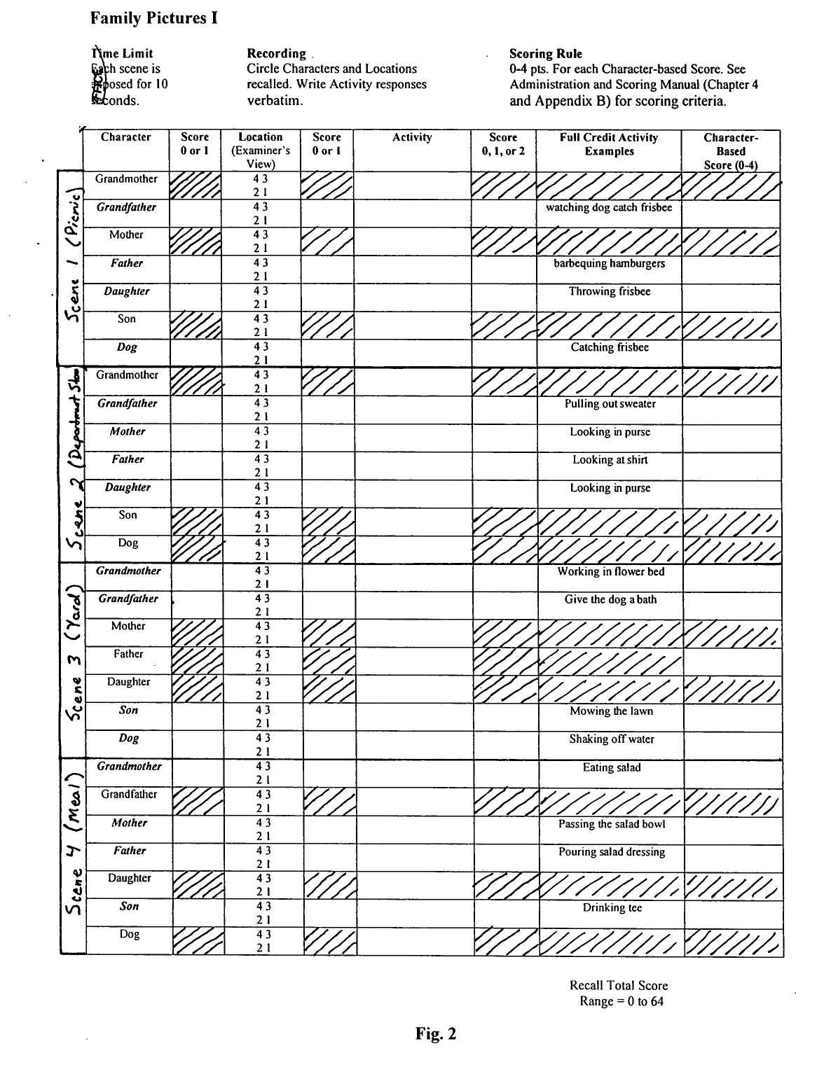

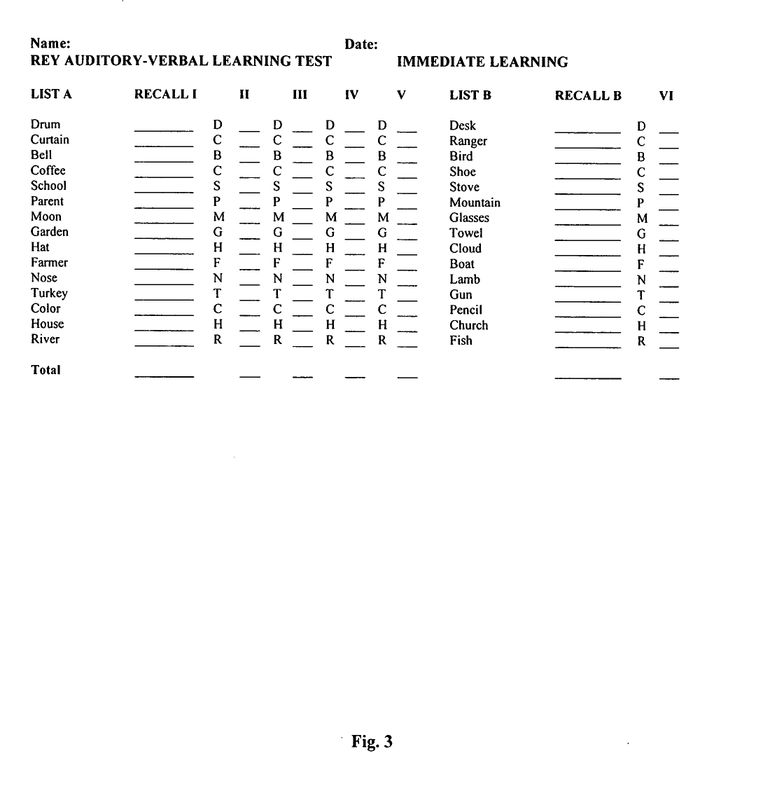

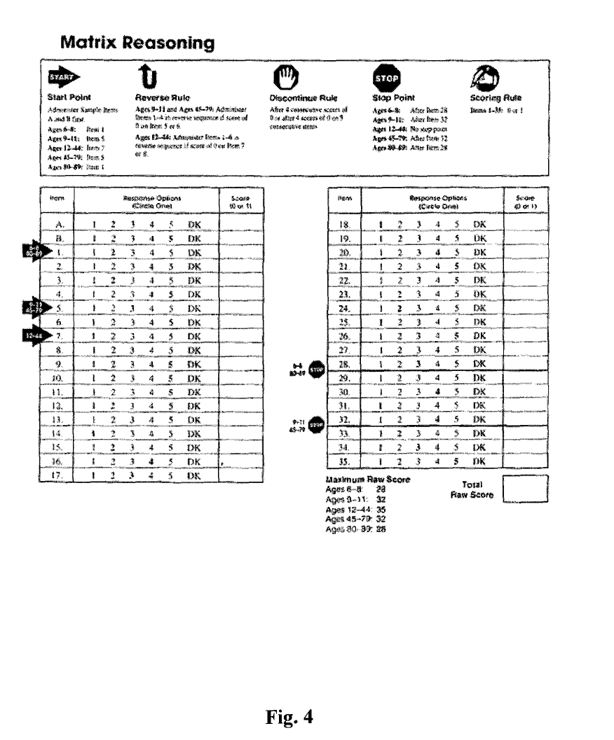

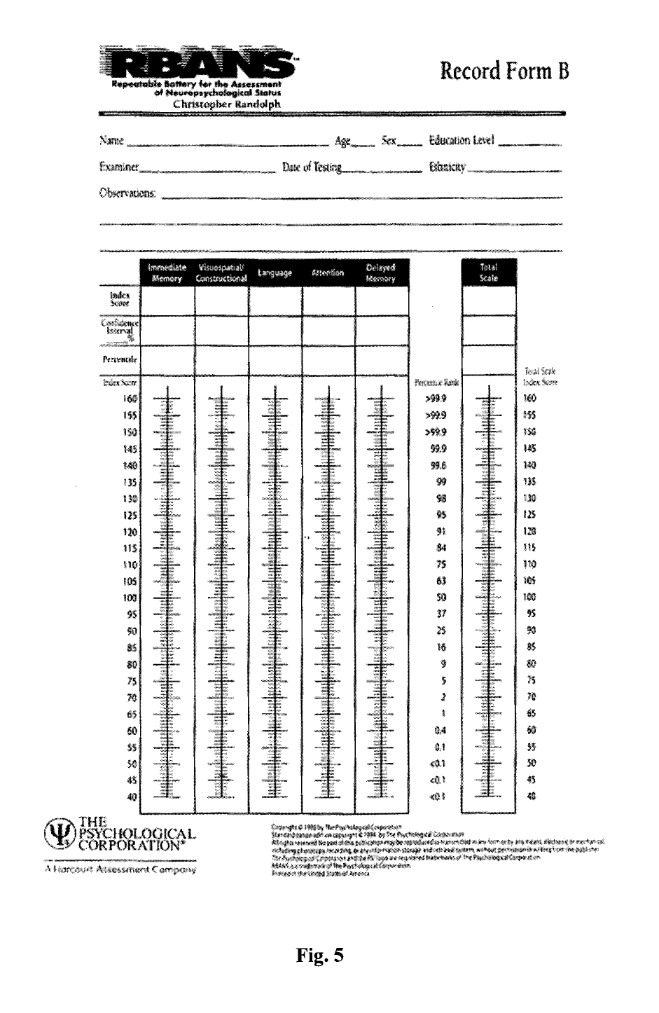

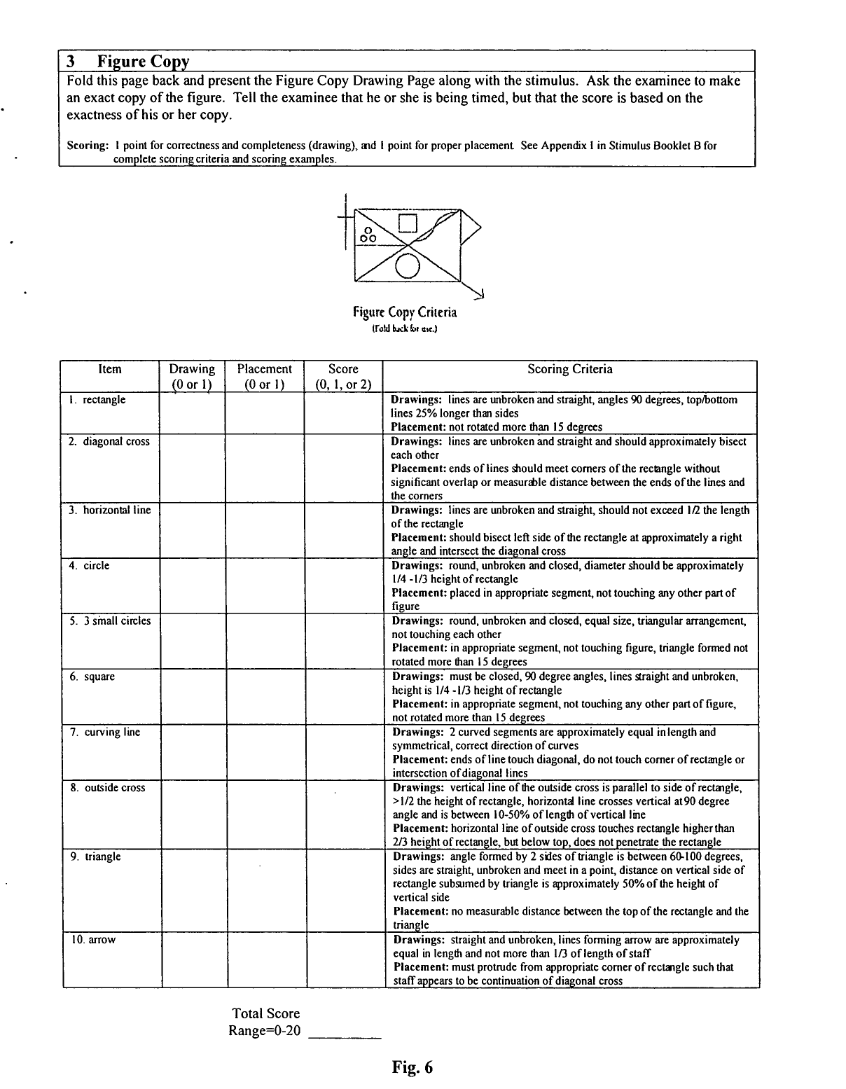

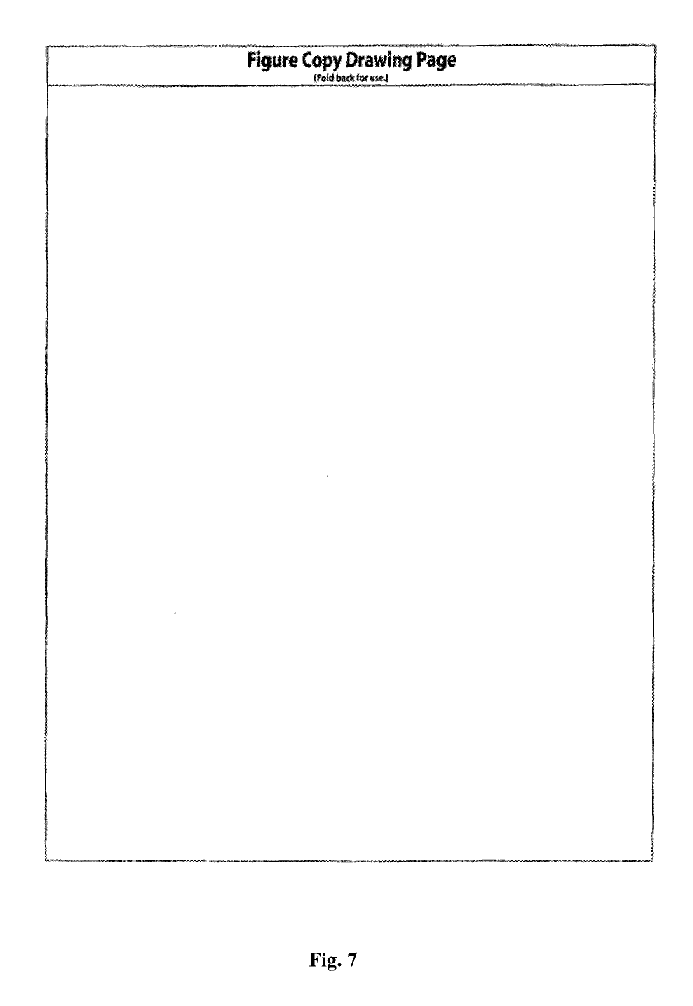

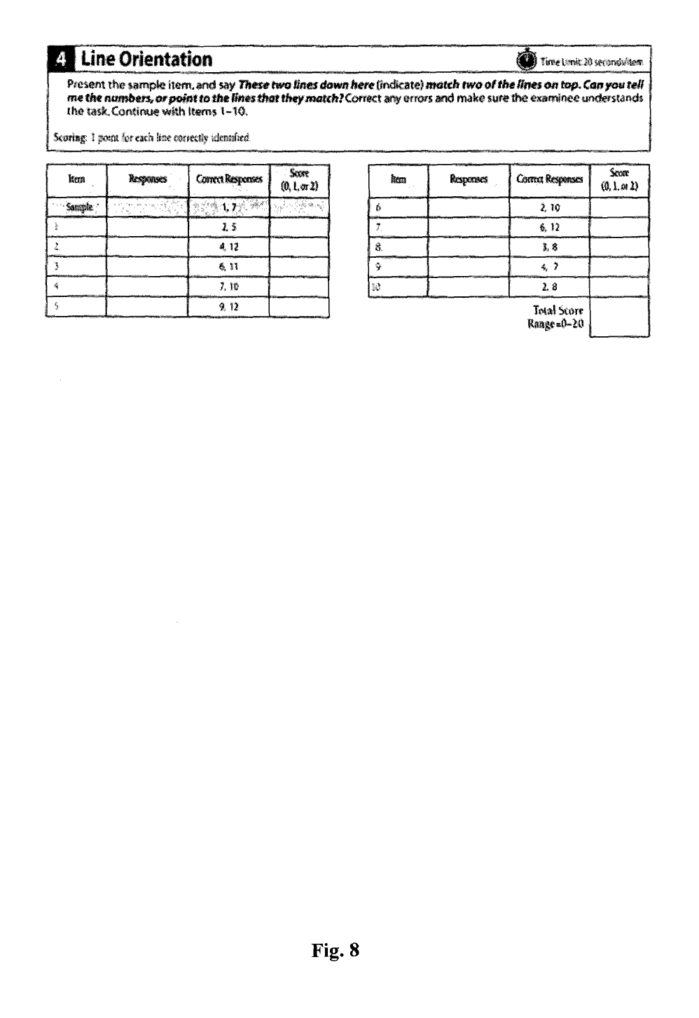

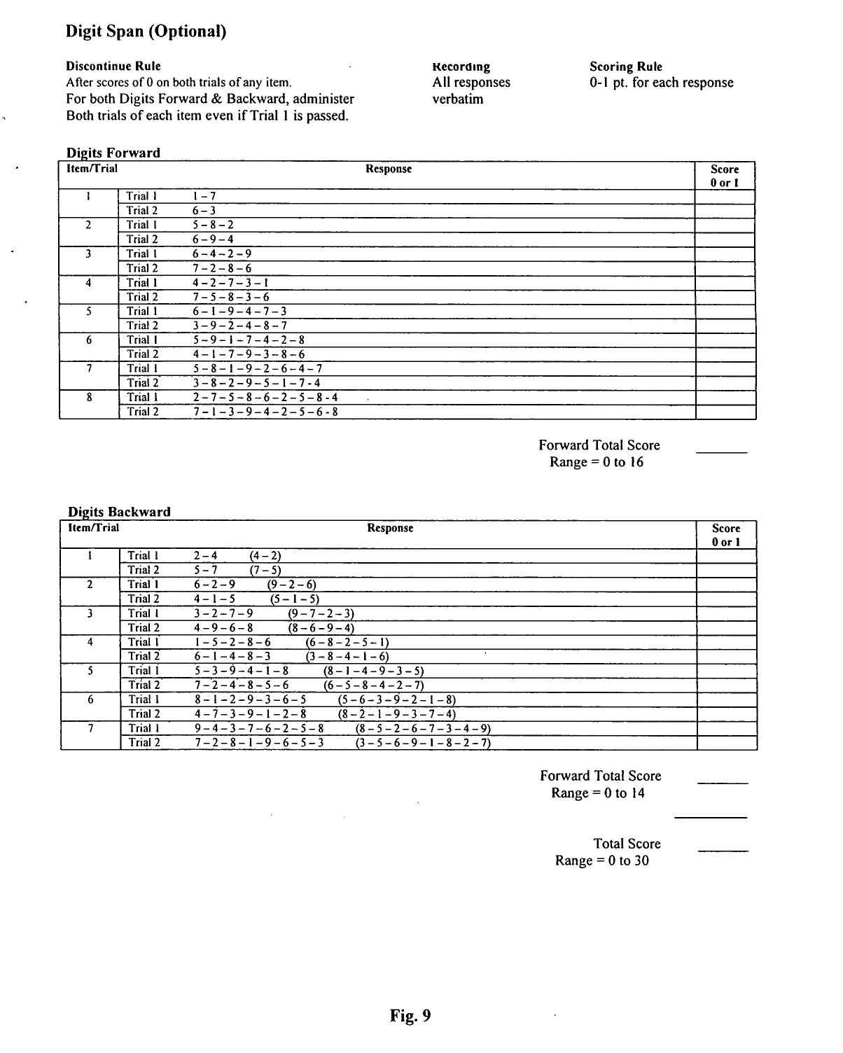

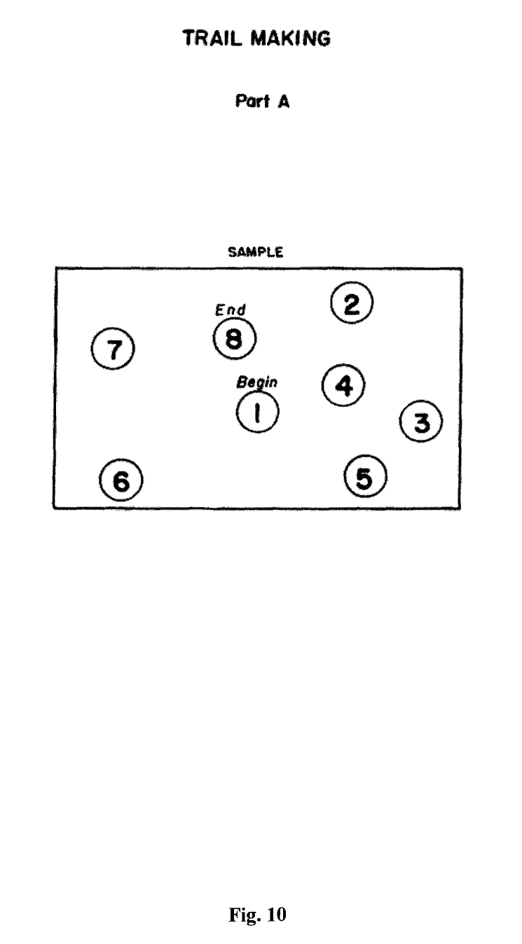

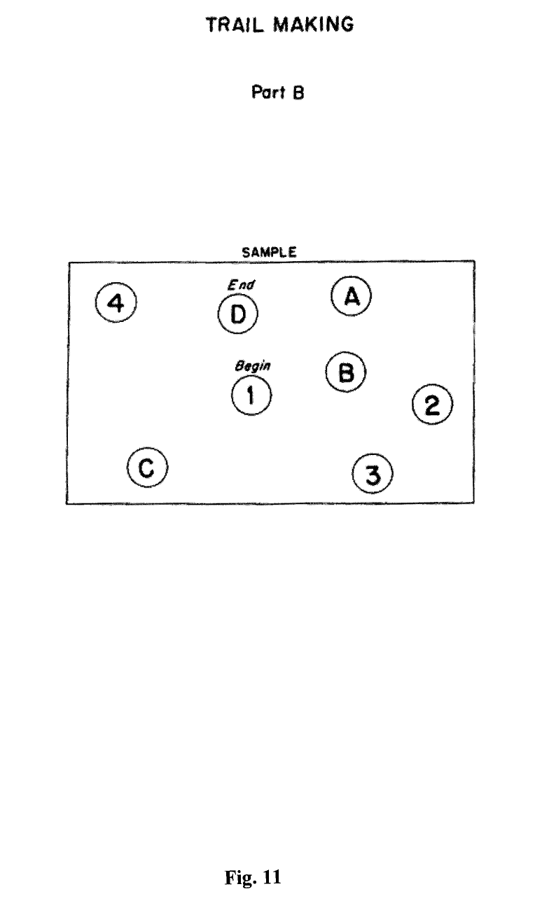

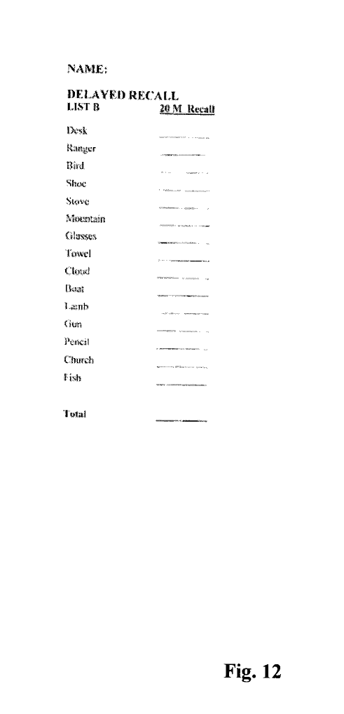

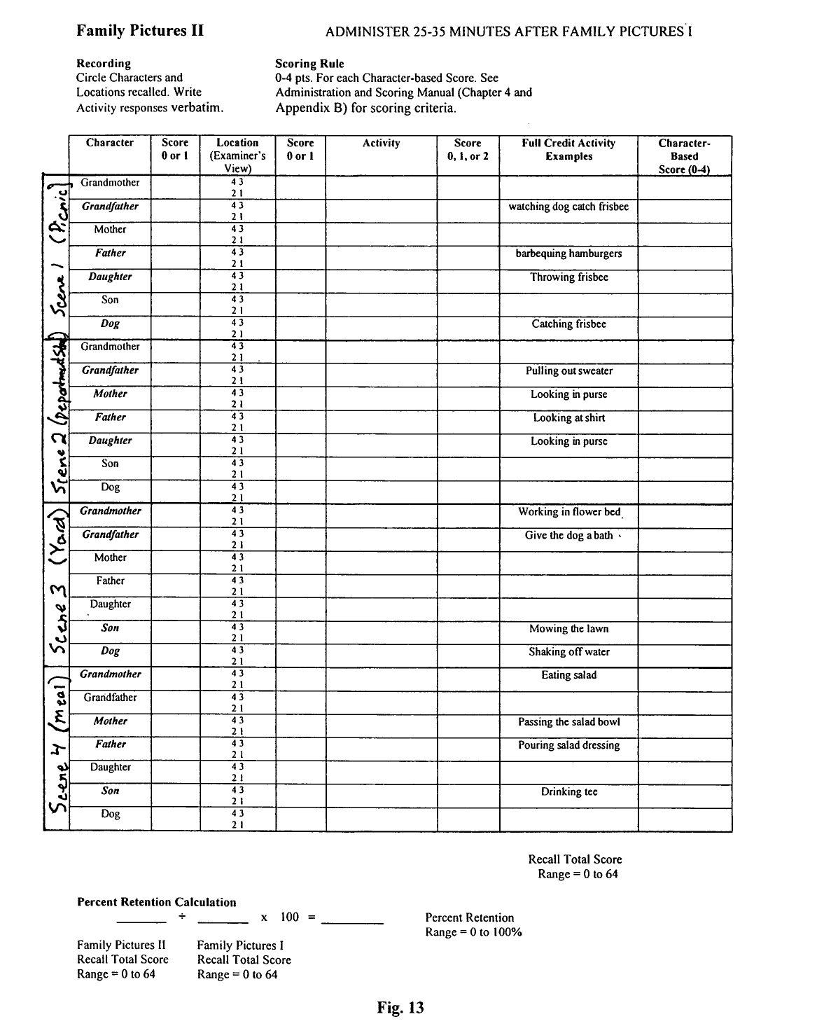

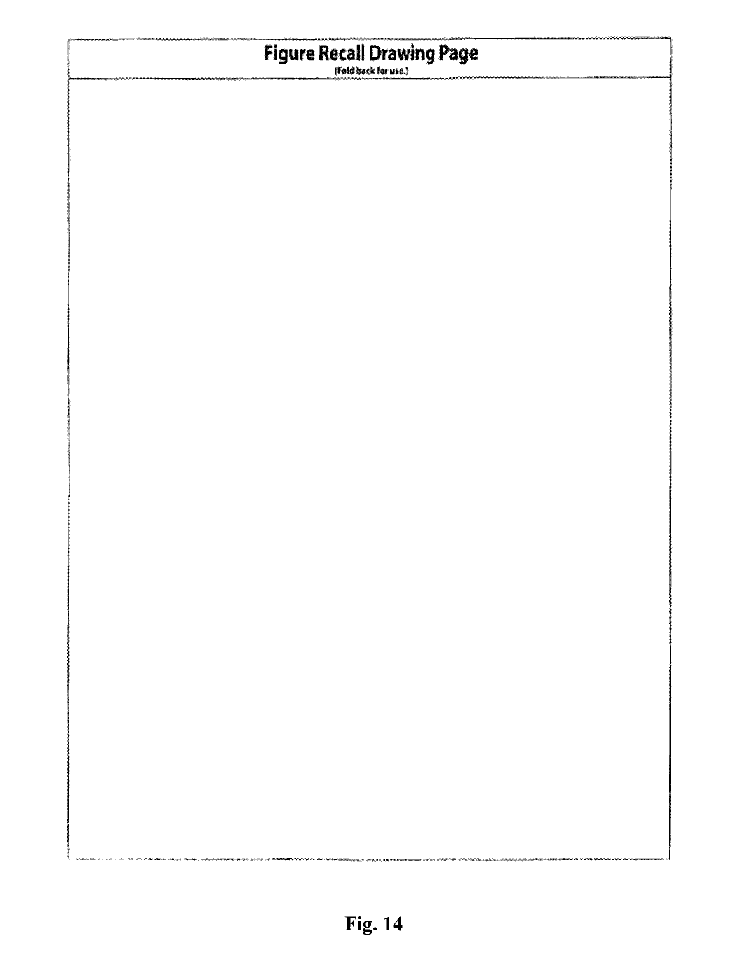

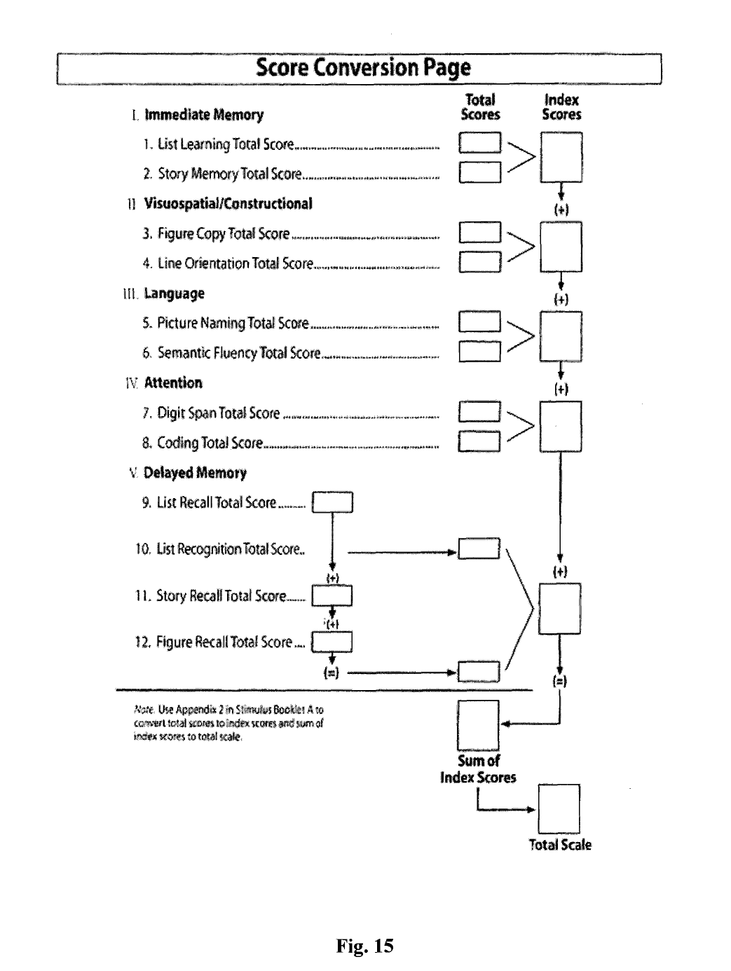

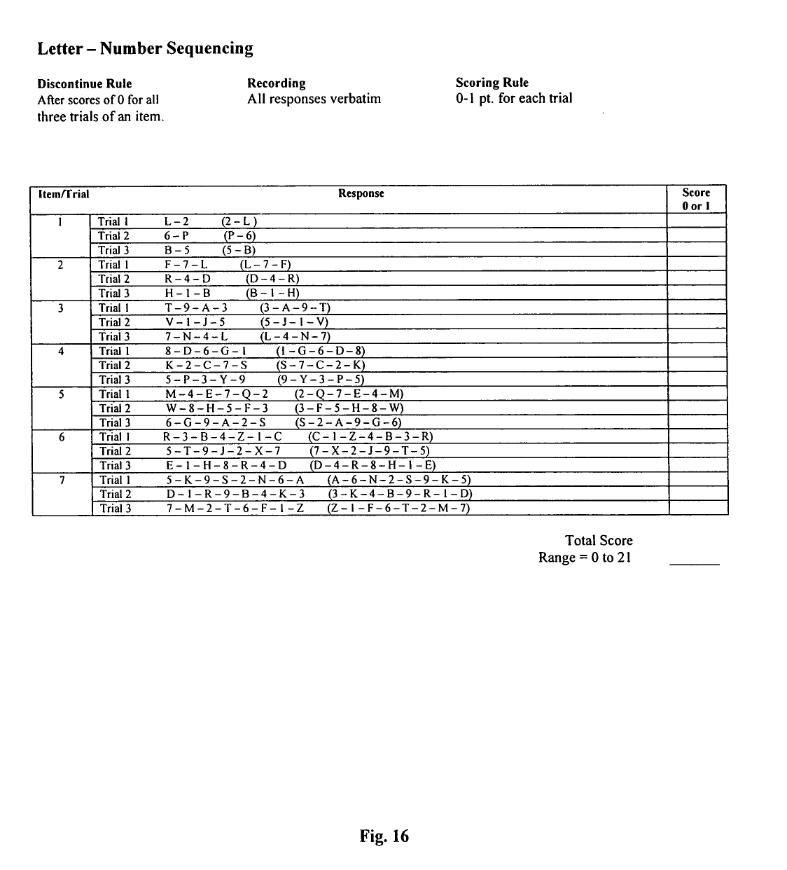

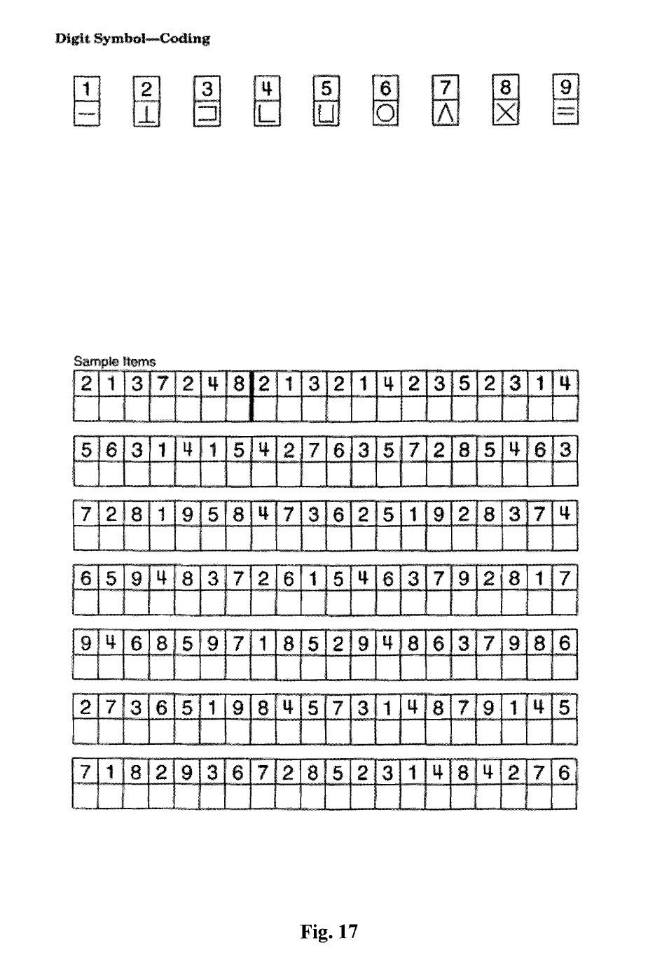

The first phase is an examination administered one-on-one by a trained professional (typically a Ph.D. or M.D.). This phase utilizes fifteen separate objective measures of functioning brain capacity that have been scientifically proven to correlate to specific parts of the brain. These tests are described and samples are provided below. This phase measures brain capacity with no subjective/opinion interference. The tasks are mostly non-verbal, which levels the playing field for all athletes regardless of educational background/opportunity. When verbal tasks are used a 5^{th} grade reading level is applied. The tasks aren't sensitive to education or reading comprehension or economic background. Each player is measured and ranked against their same position competitors and overall league, conference, or NCAA data base across: memory acquisition, memory retention, learning curve, reasoning/problem solving, attentional focus, processing speed, and visual motor capacity. A user friendly verbal account divided into “Strengths, Concerns, and Impressions” is provided to assist the teams in understanding how these areas of brain capacity relate to on field performance issues. A sample of such a report is provided in FIG. 1.

The driving principle behind every test of the first phase and how it relates to “on field” performance from the neck up is simply that the same part of the brain that allows a player to learn, remember, pay attention, process information during the examination is the same part of the brain that the player is going to use to remember, pay attention, and process information on the field, sidelines, or in practice.

Short Term Memory—Measures a player's ability to store new information. This functional area is measured by two separate tests or tasks. The first is a visual memory task in which the player is exposed to four different visual scenes/pictures on a card for ten seconds. Each scene has variety of people doing various activities in different parts of the picture. The player is shown all four scenes then asked to remember which people where in each scene, what activity they were doing, and which part of the picture they were in. This has obvious implications for learning from game film, picking up offensive and defensive schemes, dry-erase board coaching examples, etc. The second task measures how much information a player has actually been able to get in after five learning trials on a word list with a distraction thrown in to see how sensitive the player is to distraction.

Learning Curve—Measures how quickly and clearly a player learns or picks up new information. The difference between learning cure and short term memory is that short term memory measures how much of the information that a player has seen and heard actually gets stored in memory. In contrast, learning curve measures how fast or quickly the player is able to store it. Learning curve is measured by two separate tests. The first measure uses the visual memory task described above with the four pictures/scenes and calculates how quickly via a stopwatch that the players are able to get information on which people are in the scenes, where in the picture they are, and what exactly they are doing. The second learning curve task requires the player to learn fifteen words (5th grade reading level to remove educational influence) over five back-to-back repetitions of the list. Each time the list is read the player is asked to recall as many words as possible—this process is repeated five times. This has implications for how many times a player must hear something from a coach or teammate before actually being able to remember or learn it.

Reasoning/Problem Solving—A player's ability to problem solve and reason through visual scenarios quickly and accurately. This is measured with one unique task in which the player is presented with a series of visual “puzzles” in which he has to figure out the pattern, logic, or reasoning of the puzzles in order to arrive at the correct solution under time pressure. Implications for ability to think and problem solve “on their feet”—spur of the moment—and arrive at a correct response.

Attentional Focus—Measures a player's ability to pay attention and concentrate on a task while ignoring distraction. While a player's ability to pay attention is required on every task or test, this area is measured specifically by three separate measures. In the first task, the player is read a series of numbers of increasing difficulty and asked to repeat them back to the examiner. In the second task the player is given a series of mixed up numbers and letters and required to give the examiner all the number he heard first—lowest to highest—then the letters in alphabetical order. The third task involves purposefully distracting a player in the middle of a learning/memory task with a brand new list of words to supposedly learn, only to be asked to go back to the original/previous list. The number of words lost between learning trials indicates a player's sensitivity to distraction while trying to learn new information. A player's ability to “pay attention” is crucial at every position, every play, and every coaches/teammates instruction. Learning numbers uses the exact same part of the brain that is utilized to “pay attention.” If a player can pay attention on the test battery, they can pay attention elsewhere.

Short Term Memory Retention—A player's ability to recall and recognize previously learned information. While short term memory is how much information a player is able to store initially and learning curve is how quickly and clearly a player can learn that information, memory retention is how much of the previously learned information the player is actually able to hang on to and recall after a time delay and distraction. This is measured by three separate tasks. The first task uses the visual memory task involving the different people doing different things in different parts of four separate visual pictures. A player is asked to recall the information he learned during the initial ten second exposure to the four separate pictures after forty minutes of other testing. The amount of information the player is able to recall after forty minutes is compared to how much he was able to remember immediately after seeing the pictures. In the second task the player is asked to recall the words from the word list he initially learned at the beginning of the testing session. The number of words he is able to recall after forty minutes is compared to the number he was able to initially recall immediately after hearing the words. In the third task the player is shown a complex geometric figure with twenty unique features, such as circles, squares, triangles, or lines, at the beginning of the testing session. During memory retention the player is asked draw as many parts of the geometric figure he can possibly remember from memory and is graded on content and positioning.

Processing Speed—Sheer speeds in which a player can coordinate what his eyes see, his mind tells him, and react physically using his hands. This is tested in two separate tasks, both of which follow similar concepts. First, the player is shown a series of boxes, which are divided in half. The top half of each box contains a simple shape, while bottom half contains a number. The player is allowed to practice so he understands the concept fully. Then the player is asked to visually scan a series of boxes where the number is provided, but not the shape, and add the correct shape in the blank space while being timed. The task requires the player to visually see the number, match it with the correct number in his head, and place the correct shape in the blank space as quickly as possible, under the pressure of being timed. The second task is a timed visual search task in which the player is given a target symbol and asked if that target symbol can be found in a group of five symbols to the right of the target symbol. Neither task is difficult, but the speed at which a player can move through these tasks is what determines his processing speed. These tasks implicate a player's ability to visually scan a playing field, practice film, etc., his brain to understand what his seeing, and physically react. Again, finding symbols on a sheet of paper utilizes the same part of the brain that a linebacker does in reacting and breaking on the football.

Visual Motor Capacity—Similar to Processing Speed, but directed more to instinct and natural athleticism. The test measures coordination of attention/concentration, processing speed, and physical reaction time/abilities. It is measured with two separate tasks. First, the player is given a blank page with randomly placed circles with numbers inside. The player must visually scan the page, connect the numbers in order as quickly as possible. The second task is more difficult and involves more attention/concentration. The page is full of circles with numbers and letters inside. The player must connect the numbers and letters in correct order; alternating each time between the correct number and associated letter of the alphabet as fast as possible. Similar, on field implications processing speed, for a player's ability to visually scan a playing field, practice film, etc., his brain to understand what his seeing, and physically react.

The second phase is significantly more in-depth with many applications, but typically is most useful in high profile players pre-draft and/or post-draft/pre-cut scenarios. It is in that post-draft pre-season that decisions are made about which players are going to get a jersey and a salary. Every year most of the players work themselves into or out of a position, but organizations are still left with four to eight close cases each year. In addition, to the areas tested in the first phase, the second phase testing assess a wide variety of other areas specific to a team's concerns, such as: visual-spatial reaction time, which correlates to physical skills such as a player's initial reflex to break on the ball; functional language, i.e., reading speed, accuracy, and comprehension, which can implicate a player's ability to comprehend and retain information from a team's playbook; use of feedback on trial and error problem solving tasks, which reflects a player's reaction to coaching; and, fine-motor dexterity and speed with hands, attention to visual detail, i.e. recognizing play schemes. The second phase delivers extra information above and beyond the first phase that would be very useful in a situation when there are millions of dollars on the line and checks in the win column in the balance.

The third phase is reserved for those obviously gifted athletes that physically out-perform their nearest competitor by a clear margin, yet are continuing to have trouble with mental mistakes, learning, recognition, attentional focus, processing of new information, etc. A situation like this is very frustrating to both player and staff. The in-depth assessment of all cognitive strengths and weaknesses (3-4½ hours), can assist staff and player in maximizing a player's cognitive strengths, while minimizing and improving his cognitive weaknesses.

The method and system described herein essentially “maps out” and measures a players functional brain capacity in areas such as attention/concentration (visual/verbal), processing speed, language, short-term memory (visual/verbal), visual spatial skills, problem solving/reasoning, perceptual-motor integration, learning curve, language skills, sensory-motor functioning, and general overall cognitive functioning.

The preferred embodiments of the invention have been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

We claim:

1. A method for evaluating a first athlete, comprising the steps of:
administering a first battery of objective tests directed to assessing said first athlete's functioning brain capacity to said first athlete;
determining a first set of test scores for said first athlete based on said first battery of objective tests;
providing a data base comprising at least a first set of competitive scores from at least a second athlete, said second athlete and said first athlete sharing at least one common identifier;
comparing said first set of test scores for said first athlete with said at least first set of competitive test scores; and
ranking said first set of test scores for said first athlete relative to said at least first set of competitive test scores.

2. The method for evaluating an athlete as set forth in claim 1, wherein at least one of said objective tests from said first battery comprises only non-verbal tasks.

3. The method for evaluating a first athlete as set forth in claim 1, wherein each of said objecting tests from said first battery comprises only non-verbal tasks.

4. The method for evaluating a first athlete as set forth in claim 1, wherein each of said objective tests from said first battery comprises tasks from the group consisting of non-verbal tasks and verbal tasks using no more than a fifth grade reading level.

5. The method for evaluating a first athlete as set forth in claim 1, wherein said objective tests from said first battery comprise a short term memory test; a learning ability test; a reasoning and problem solving ability test; an attentional focus test; a short term memory retention test; a processing speed test; and a visual motor capacity test.

6. The method for evaluating a first athlete as set forth in claim 5, wherein said short term memory test comprises a visual memory test and a list learning/distraction test.

7. The method for evaluating a first athlete as set forth in claim 6, wherein said visual memory test comprises the following steps:
exposing said first athlete to at least one visual scene;
removing said visual scene from said first athlete's sight; and
asking said first athlete at least one question about said visual scene.

8. The method for evaluating a first athlete as set forth in claim 6, wherein said list learning/distraction test comprises the following steps:
exposing said first athlete to a list of items;
removing said list of items from said first athlete's sight;
exposing said first athlete to at least one unrelated stimulus; and
asking said first athlete at least one question about said list of items.

9. The method for evaluating a first athlete as set forth in claim 5, wherein said learning ability test comprises a timed visual memory test and a list learning test.

10. The method for evaluating a first athlete as set forth in claim 9, wherein said timed visual memory test comprises the following steps:
exposing said first athlete to at least one visual scene;
removing said visual scene from said first athlete's sight;
asking said first athlete at least one question about said visual scene; and
timing said first athlete' response to said question.

11. The method for evaluating a first athlete as set forth in claim 9, wherein said list learning test comprises the following steps:
exposing said first athlete to a list of items;
removing said list of items from said first athlete's sight; and
asking said first athlete to recall and identify said list of items.

12. The method for evaluating a first athlete as set forth in claim 5, wherein said reasoning and problem solving ability test comprises a visual puzzle test.

13. The method for evaluating a first athlete as set forth in claim 12, wherein said visual puzzle test comprises the following steps:
exposing said first athlete to at least one visual puzzle having a pattern;
asking said first athlete to identify said pattern associated with said visual puzzle; and
timing first athlete's identification of said pattern.

14. The method for evaluating a first athlete as set forth in claim 5, wherein said attentional focus test comprises a sequence recollection test, a recollection/reordering test, and a recollection/distraction test.

15. The method for evaluating a first athlete as set forth in claim 14, wherein said sequence recollection test comprises the following steps:
exposing said first athlete to at least one numerical sequence; and
asking said first athlete to recall and repeat said numerical sequence.

16. The method for evaluating a first athlete as set forth in claim 14, wherein said recollection/reordering test comprises the following steps:
exposing said first athlete to a non-consecutive series of numbers and letters; and
asking said first athlete to recall and recite said numbers and letters in, respectively, numerical and alphabetical order.

17. The method for evaluating a first athlete as set forth in claim 14, wherein said recollection/distraction test comprises the following steps:
exposing said first athlete to a list of items;
removing said list of items from said first athlete's sight;
exposing said first athlete to at least one unrelated stimulus; and
asking said first athlete to recall and identify said list of items.

18. The method for evaluating a first athlete as set forth in claim 5, wherein said short term memory retention test comprises a distracted visual memory test, a distracted recollection list test, and a distracted recollection figure test.

19. The method for evaluating a first athlete as set forth in claim 18, wherein said distracted visual memory test comprises the following steps:
exposing said first athlete to at least one visual scene;
removing said visual scene from said first athlete's sight;
exposing said first athlete to at least one unrelated stimulus for at least thirty minutes; and
asking said first athlete at least one question about said visual scene; and

20. The method for evaluating a first athlete as set forth in claim 18, wherein said distracted recollection list test comprises the following steps:
exposing said first athlete to a list of items;
removing said list of items from said first athlete's sight;
exposing said first athlete to at least one unrelated stimulus for at least thirty minutes; and
asking said first athlete at least one question about said list of items.

21. The method for evaluating a first athlete as set forth in claim 18, wherein said distracted recollection figure test comprises the following steps:
exposing said first athlete to a geometric figure;
removing said geometric figure from said first athlete's sight;
exposing said first athlete to at least one unrelated stimulus for at least thirty minutes; and
asking said first athlete to recall and draw said geometric figure.

22. The method for evaluating a first athlete as set forth in claim 5, wherein said processing speed test comprises a timed association test and a timed visual search test.

23. The method for evaluating a first athlete as set forth in claim 22, wherein said timed association test comprises the following steps:
exposing said first athlete to at least one association of first and second items;
removing said association from said first athlete's sight;
exposing said first athlete to a stimulus having one of said first and second items of said association;
asking said first athlete to recall the other of said first and second items of said association; and
timing how long it takes said first athlete to recall the other of said first and second items of said association.

24. The method for evaluating a first athlete as set forth in claim 22, wherein said timed visual search test comprises the following steps:
exposing said first athlete to a target item;
removing said target item from said first athlete's sight;
exposing said first athlete to at least two visual stimuli, one of said visual stimuli being said target item;
asking said first athlete to recall and identify said target item among said visual stimuli; and
timing how long it takes said first athlete to identify said target item among said visual stimuli.

25. The method for evaluating a first athlete as set forth in claim 5, wherein said visual motor capacity test comprises first and second timed sequencing tests.

26. The method for evaluating a first athlete as set forth in claim 25, wherein said first timed sequencing test comprises the following steps:
exposing said first athlete to randomized series of numbers;
asking said first athlete to connect each of said numbers in a designated manner; and
timing said first athlete's ability to connect said numbers in said designated manner.

27. The method for evaluating a first athlete as set forth in claim 25, wherein said second sequencing test comprises the following steps:
exposing said first athlete to randomized series of numbers and letters;
asking said first athlete to connect each of said numbers and letters in a designated manner; and
timing said first athlete's ability to connect said numbers in said designated manner.

28. The method for evaluating a first athlete as set forth in claim 1, wherein said objective tests from said first battery are selected from the group consisting of a short term memory test; a learning ability test; a reasoning and problem solving ability test; an attentional focus test; a short term memory retention test; a processing speed test; and a visual motor capacity test.

29. The method for evaluating a first athlete as set forth in claim 1, wherein said common identifier is selected from the group consisting of competitive level of play, conference, team, and position of play.

30. The method for evaluating an athlete as set forth in claim 1, further comprising the steps of:
identifying a set of specific issues associated with said first athlete's on-field performance; and
subjecting said first athlete to a second battery of objective tests directed to said set of specific issues;
determining a second set of test scores for said first athlete upon completion of said second battery of objective tests;
providing at least a second set of competitive scores from at least said second athlete in said data base;
comparing said second set of test scores for said first athlete with said at least second set of competitive test scores; and
ranking said second set of test scores for said first athlete relative to said at least second set of competitive test scores.

31. The method for evaluating a first athlete as set forth in claim 30, wherein said specific issues associated with said first athlete's on-field performance are selected from the group consisting of: visual-spatial reaction time, functional language, use of feedback on trial and error problem solving tasks, fine-motor dexterity and hand speed, and attention to visual detail.

32. The method for evaluating a first athlete as set forth in claim 30, wherein said specific issues associated with said first athlete's on-field performance comprise visual-spatial reaction time, functional language, use of feedback on trial and error problem solving tasks, fine-motor dexterity and hand speed, and attention to visual detail.

33. The method for evaluating a first athlete as set forth in claim 30, wherein said objective tests from said second battery are selected from the group consisting of: a visual-spatial reaction time test, a functional language test, test of said first athlete's use of feedback on trial and error problem solving tasks, a fine-motor dexterity and hand speed test, and an attention to visual detail test.

34. The method for evaluating a first athlete as set forth in claim 30, wherein said objective tests from said second battery comprise a visual-spatial reaction time test, a functional language test, test of said first athlete's use of feedback on trial and error problem solving tasks, a fine-motor dexterity and hand speed test, and an attention to visual detail test.

35. The method for evaluating an athlete as set forth in claim 30, wherein at least one of said objective tests from said second battery comprises only non-verbal tasks.

36. The method for evaluating a first athlete as set forth in claim 30, wherein each of said objecting tests from said second battery comprises only non-verbal tasks.

37. The method for evaluating a first athlete as set forth in claim 30, wherein each of said objective tests from said second battery comprises tasks from the group consisting of non-verbal tasks and verbal tasks using no more than a fifth grade reading level.

38. The method for evaluating a first athlete as set forth in claim 1, further comprising the step of interviewing said first athlete to assess specific deficiencies in said first athlete's cognitive functioning.
